(19) United States
(12) Patent Application Publication
(10) Pub. No.: US 2026/0281902 A1
(43) Pub. Date: Sep. 17, 2026

(54) ULTRALOW-POWER METHOD AND APPARATUS FOR IMPROVING ENERGY EFFICIENCY OF COMMUNICATION DEVICE IN WIRELESS ENVIRONMENT

(71) Applicant: ELECTRONICS AND TELECOMMUNICATIONS RESEARCH INSTITUTE, Daejeon (KR)

(72) Inventors: Min-Suk CHOI, Daejeon (KR); Jae-Deok LIM, Daejeon (KR); Jeong-Nyeo KIM, Daejeon (KR)

(21) Appl. No.: 19/565,324

(22) Filed: Mar. 12, 2026

(30) Foreign Application Priority Data
Mar. 14, 2025 (KR) 10-2025-0033096
Feb. 13, 2026 (KR) 10-2026-0030058

(51) Int. Cl. H04W 52/02

(52) U.S. Cl. CPC H04W 52/0235

(57) ABSTRACT

Disclosed herein is an ultralow-power method and apparatus for improving energy efficiency of a communication device in a wireless environment. The ultralow-power apparatus may include a communication unit configured to receive information about one or more Low-Power Wake-Up Signal (LP-WUS) threshold zones and threshold information corresponding to each LP-WUS threshold zone from a base station and a controller configured to determine whether the apparatus belongs to any one of the one or more LP-WUS threshold zones based on a location value indicating a current location and determine whether to enter LP-WUS monitoring based on the threshold information corresponding to the determined LP-WUS threshold zone and a radio measurement value measured at the current location.

### CROSS REFERENCE TO RELATED APPLICATIONS

This application claims the benefit of Korean Patent Applications No. 10-2025-0033096, filed Mar. 14, 2025, and No. 10-2026-0030058, filed Feb. 13, 2026, which are hereby incorporated by reference in their entireties into this application.

### BACKGROUND OF THE INVENTION

### 1. Technical Field

The present disclosure relates to an ultralow-power method and apparatus for improving energy efficiency of a communication device in a wireless environment.

More particularly, the present disclosure relates to security inspection automation technology for rapidly and conveniently inspecting security vulnerabilities and formal-verification-based security verification technology for guaranteeing high-level security and safety in order to securely protect Internet-of-Things/Industrial Internet-of-Things (IoT/IIoT) devices in the IoT field, particularly in mission-critical fields closely related to the life, safety, and property of the public, and relates to a method for reducing power consumption of a terminal in order to provide services for a longer period of time by using minimum amounts of power when high-reliability-assured IoT/IIoT devices to which such formal verification is applied are operated in an actual field.

### 2. Description of the Related Art

In order to create and provide new and diverse services worldwide, demand and supply for the Internet of Things (IoT), which enables information to be transmitted and received by closely connecting things, people, and spaces through digitalization of service content, are increasing. In response to such demands for IoT, IoT devices are developed and advanced and are increasing exponentially. IoT technologies are spreading to a wide range of application fields, as well as public industrial sectors including manufacturing, smart cities, healthcare, and education. IoT devices are being applied to real life in various forms such as mobile devices, wearable devices, home appliances, etc., based on small sensors, computer devices, and wired and wireless network technology, and are evolving into more diverse forms to expand their application fields. Globally, the number of IoT devices is expected to increase to 25.4 billion by 2030, and companies and research institutions that develop and study IoT devices are conducting research on intelligent IoT technology capable of analyzing collected data and providing analysis results to application services, beyond technology that merely collects data by connecting devices.

Representative research includes handling the latest information technology, such as intelligent IoT devices, Artificial Intelligence (AI), platforms, application services, etc., and actively introducing clouds and AI to provide optimal decision-making to service users.

Various studies are being conducted on IoT devices for incorporating such IoT technologies. Representative technologies include development of AI-integrated IoT devices, high-reliability IoT devices, ultra-small IoT devices, and sensor-based IoT devices. IoT applications developed according to respective missions are mounted on devices and deployed and operated in the field. For efficient operation of IoT devices, high power efficiency is required, and to this end, power management is critical. IoT devices used in mission-critical application fields mainly utilize low-power nodes (e.g., sensor nodes), and such low-power nodes are installed in a remote site and are operated solely by batteries or by a very small amount of separate power.

From the perspective of applications of IoT technology, the power management design of a low-power node affects battery life and is closely related to operational duration. Accordingly, a low-power node remains in a sleep mode, which is a low-power state, during most of the time when it is not operating, and when transmission or reception of data is detected, it wakes up from the sleep mode and switches to an active mode to perform operations.

Generally, IoT systems use wireless sensor nodes as low-power nodes, and since they are operated by batteries, there are limitations due to battery life. For example, nodes or batteries of the nodes need to be periodically replaced or recharged. However, operations for periodic battery replacement for nodes deployed in a remote site incurs significant overhead, so a method for managing power consumption is required. A method for increasing battery life in the operation in a wireless sensor itself is to operate the sensor node at an extremely low duty cycle and to switch to a sleep mode for most of the time. Generally, a ship mode and a sleep mode are defined. The ship mode is a method of increasing battery life by maintaining a nano-power state at the product shipment stage. In the ship mode, the battery is electrically disconnected from the system load to minimize power consumption while the product is not being used. To use the node, a push button is used to switch from the ship mode to an operation mode, whereby operation may be started.

When the node is used in an operation mode, a sleep mode may be used to increase the battery life. In the sleep mode, all peripheral devices of the system of the node are shut down or configured to consume minimum power. Such a sleep mode may be applied in various forms depending on the characteristics of the node or the operation of an application mounted on the node, whereby an optimal sleep mode is applied to each node.

Various wireless resources are utilized to operate IoT devices. The resources utilized may vary depending on the distance. For short distances, wireless resources such as Bluetooth and NFC are used, whereas for medium and long distances, LTE or 5G mobile communication modems are mounted to support data communication between a node and a base station or between nodes. In 3GPP, which governs LTE and 5G NR wireless standards, various items have been identified and studied to improve battery efficiency of IoT devices that support the corresponding wireless standards. As representative examples, there is a method of reducing energy consumption by reducing bandwidth allocation through a BWP connection with a minimum allowable bandwidth when traffic is low or by reducing signaling procedures performed by a terminal, such as 2Step RACH. Also, when no data transmission or reception occurs, a method of remaining in a sleep mode and preventing unnecessary wake-up during a DRX cycle by applying a DRX mechanism is applied. Up to 3GPP Rel-15, release from the sleep mode according to the DRX cycle was determined based on a predefined cycle, but from Rel-16, a mechanism was added to allow a continuous sleep mode even upon reaching the sleep mode release cycle. Also, in Rel-16, a method such as UEAssistanceInformation was added to enable a terminal to quickly release resources and transition to an idle state.

Particularly, a method has been proposed to allow a UE to select not to release a power-saving state unless it receives a specific signal referred to as a ‘Wake-Up Signal (WUS)’ from a network. This technology is referred to as Low-Power WUS (LP-WUS), and items related thereto are being studied. LP-WUS is technology for providing ultra deep sleep, which offers a longer power-saving time than a deep sleep period, which is a power-saving time of a main RF module (Main Radio (MR)). This technology reduces power consumption by delaying, as much as possible, the time at which the UE wakes up from a sleep state to monitor a Physical Downlink Control Channel (PDSCH) based on scheduling information provided by a Physical Downlink Shared Channel (PDSCH). A UE to which LP-WUR/WUS is applied has a Low-Power (LP) receiver for receiving an LP-WUS, separately from a receiver for the MR. The basic operation is configured such that the MR of the UE enters an ultra-deep sleep mode and the LP receiver performs only monitoring for receiving the LP-WUS. When the LP-WUR receives the LP-WUS, it wakes up the UE, turns on the MR receiver, and wakes up from the ultra-deep sleep (UDS) mode to monitor PDCCH. For the LP-WUR/WUS, there are a duty-cycled mode and a continuous mode, which are based on different mechanisms.

### SUMMARY OF THE INVENTION

An object of the present disclosure is to provide an ultralow-power method and apparatus for improving energy efficiency of a communication device in a wireless environment, which can analyze an LP-WUS method for reducing power consumption of an IoT device and improving battery efficiency and can solve problems of the LP-WUS method.

Another object of the present disclosure is to provide an ultralow-power method and apparatus for improving energy efficiency of a communication device in a wireless environment in order to raise and solve issues currently being discussed in 3GPP with respect to entry and exit conditions among LP-WUR/WUS items.

A further object of the present disclosure is to provide an ultralow-power method and apparatus for improving energy efficiency of a communication device in a wireless environment, which may dynamically define and manage threshold criteria for Reference Signal Received Power/Reference Signal Received Quality (RSRP/RSRQ) of an MR and a Low-Power Synchronization Signal (LP-SS) value in order to reduce malfunction related to LP-WUS entry and exit conditions.

Yet another object of the present disclosure is to provide an ultralow-power method and apparatus for improving energy efficiency of a communication device in a wireless environment, which may solve a ping-pong problem caused by an LP-WUS boundary region and unstable MR/LR reception.

A wireless communication method performed by a user equipment (UE) according to the present disclosure may include receiving, by the UE, information about one or more Low-Power Wake-Up Signal (LP-WUS) threshold zones and threshold information corresponding to each LP-WUS threshold zone from a base station, determining, by the UE, whether the UE belongs to any one of the one or more LP-WUS threshold zones based on a location value indicating a location of the UE, and determining, by the UE, whether to enter LP-WUS monitoring based on an LP-WUS entry threshold included in threshold information corresponding to the determined LP-WUS threshold zone and a radio measurement value measured by the UE. Here, the location value may be received by the base station or estimated by the UE. The location value may include at least one of absolute coordinate information, cell-based location information, zone-based location information, or information indicating a relative location, or a combination thereof. The radio measurement value includes at least one of Reference Signal Received Power (RSRP), Reference Signal Received Quality (RSRQ), or timing information, or a combination thereof measured through a main receiver (MR) or a low-power receiver (LR) of the UE. The information about the LP-WUS threshold zones may include zone identification information for identifying an LP-WUS threshold zone and information indicating a spatial range of each zone.

Determining whether to enter the LP-WUS monitoring may include comparing, by the UE, an LP-WUS entry threshold corresponding to the determined LP-WUS threshold zone with a radio measurement value measured through a main receiver of the UE and determining whether the radio measurement value satisfies the LP-WUS entry threshold.

The LP-WUS threshold zones may be configured to have identical sizes or different sizes.

The LP-WUS threshold zones include a plurality of LP-WUS threshold zones having different thresholds, and the threshold information may include different thresholds depending on the LP-WUS threshold zone entered by the UE.

The wireless communication method performed by the UE may further include, after the UE enters the LP-WUS monitoring, determining whether to exit the LP-WUS monitoring based on a radio measurement value measured through a low-power receiver and an LP-WUS exit threshold included in the threshold information corresponding to the LP-WUS threshold zone.

The wireless communication method performed by the UE may further include, even if an exit condition is satisfied after entering the LP-WUS monitoring, maintaining an LP-WUS state for a predefined time period and then determining whether to exit the LP-WUS monitoring. Here, the predefined time period may be calculated by comparing energy consumed by entering and exit the LP-WUS monitoring with energy gain obtained by maintaining the LP-WUS state. The predefined time period, X, may be determined to be T1 that satisfies (T1×W3)−(T1×W2)≥W1 based on W1, W2, and W3, and W1 denotes total power consumption from entry into LP-WUS monitoring to immediate exit, W2 denotes power consumption per unit time during the time period T1 after entry into the LP-WUS monitoring, and W3 denotes power consumption per unit time during the time period T1 after entry into LP-WUS eDRX or DRX.

The wireless communication method performed by the UE may further include transmitting, by the UE, first location information including the location value and the radio measurement value to the base station and transmitting, by the UE, second location information including a second location value indicating a location of the UE after entry into the LP-WUS monitoring and a second radio measurement value corresponding to the second location value to the base station. The second radio measurement value may include an RSRP/RSRQ value of a main receiver (MR) corresponding to the second location value and a location value and an RSRP/RSRQ value of an LP-SS of a low-power receiver (LR) when an LP-WUS exit condition is satisfied, and the LP-WUS threshold zones may be generated or updated based on the first location information or the second location information.

A wireless communication method performed by the base station may include configuring, by the base station, one or more Low-Power Wake-Up Signal (LP-WUS) threshold zones and threshold information corresponding to each LP-WUS threshold zone based on location information reported from a user equipment (UE) and transmitting, by the base station, information about the one or more LP-WUS threshold zones and the threshold information corresponding to each LP-WUS threshold zone to a UE entering a cell. Here, the location information may include a location value indicating a location of the UE and a radio measurement value. The radio measurement value may include at least one of Reference Signal Received Power (RSRP), Reference Signal Received Quality (RSRQ), or timing information, or a combination thereof measured through a main receiver (MR) or a low-power receiver (LR) of the UE.

The LP-WUS threshold zones configured by the base station may include uniform zones configured to have identical sizes or non-uniform zones configured to have different sizes.

The information about the LP-WUS threshold zones may include zone identification information for identifying an LP-WUS threshold zone or information indicating a spatial range of the LP-WUS threshold zone, and the threshold information may include an entry threshold for entry into LP-WUS monitoring and an exit threshold for exit from LP-WUS monitoring.

Transmitting the information about the one or more LP-WUS threshold zones and the threshold information may include transmitting the information about the LP-WUS threshold zones and the threshold information through system information when the UE moves from outside to inside a coverage area of the cell.

The wireless communication method performed by the base station may further include receiving, by the base station, updated location information from a UE that enters the cell; and dynamically reconfiguring, by the base station, the LP-WUS threshold zones or the threshold information based on the updated location information.

A user equipment for wireless communication according to the present disclosure may include a communication unit configured to receive information about one or more Low-Power Wake-Up Signal (LP-WUS) threshold zones and threshold information corresponding to each LP-WUS threshold zone from a base station and a controller configured to determine whether the UE belongs to any one of the one or more LP-WUS threshold zones based on a location value indicating a current location and to determine whether to enter LP-WUS monitoring based on the threshold information corresponding to the determined LP-WUS threshold zone and a radio measurement value measured at the current location.

Abase station for wireless communication according to the present disclosure may include a controller configured to configure one or more Low-Power Wake-Up Signal (LP-WUS) threshold zones and threshold information corresponding to each LP-WUS threshold zone based on location information reported from a User Equipment (UE) and a communication unit configured to transmit information about the one or more LP-WUS threshold zones and the threshold information corresponding to each LP-WUS threshold zone to a UE entering a cell.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a normal LP-WUS entry/exit scenario according to an embodiment of the present disclosure;

FIG. 2 is a view illustrating an LP-WUS entry/exit scenario in which an error occurs according to an embodiment of the present disclosure;

FIG. 3 is a view illustrating a method of generating an LP-WUS threshold zone according to an embodiment of the present disclosure;

FIG. 4 is a view illustrating transmission of location information between a base station and an IoT device according to an embodiment of the present disclosure;

FIG. 5 is a view illustrating a uniform method and a non-uniform method for configuring LP-WUS threshold zones according to an embodiment of the present disclosure;

FIG. 6 is a view illustrating a method of defining a dynamic threshold for an LP-WUS exit condition according to an embodiment of the present disclosure;

FIG. 7 is a view illustrating a method for uniform threshold zones and non-uniform threshold zones based on LP-WUS entry and exit conditions according to an embodiment of the present disclosure;

FIG. 8 is a view illustrating LP-WUS entry and exit ping-pong situations and solution methods according to an embodiment of the present disclosure;

FIG. 9 is a block diagram illustrating the configuration of an ultralow-power system for improving energy efficiency of a communication device in a wireless environment according to an embodiment of the present disclosure;

FIG. 10 is a flowchart illustrating a process of a wireless communication method performed by a communication device in order to implement an ultralow-power method for improving energy efficiency of a communication device in a wireless environment according to an embodiment of the present disclosure;

FIG. 11 is a flowchart illustrating a process of a wireless communication method performed by a network device in order to implement an ultralow-power method for improving energy efficiency of a communication device in a wireless environment according to an embodiment of the present disclosure; and

FIG. 12 is a view illustrating the configuration of a computer system according to an embodiment of the present disclosure.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in embodiments are independently illustrated in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

At least portion of the parts, units, and modules described in the embodiments may be program modules and may communicate with external devices or systems.

The program modules may include a routine, a subroutine, a program, an object, a program component, a data structure, and the like for performing functions or operations according to an embodiment or for implementing abstract data types according to an embodiment, but they are not limited thereto.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

The LP-WUR/WUS items have been applied since Rel-15, and ideas related to the items have been continuously proposed through studies and contributions up to the recent 3GPP RAN2 meeting #128. The ideas may be summarized as follows:
Subgrouping: This relates to a method of dividing and allocating UEs applying LP-WUR/WUS into subgroups in order to reduce false wakeups and enhance power reduction efficiency. In Rel-17, PEI subgrouping supports up to eight subgroups, and it was concluded that configuring LP-WUS based thereon is reasonable.
Entry/exit condition: This specifies procedure and configuration of LP-WUS indicating paging monitoring triggered by LP-WUS, including at least configuration, subgrouping, and entry/exit conditions for LP-WUS monitoring. In RAN1, the LP-WUS entry/exit conditions are based on Reference Signal Received Power (RSRP) and Reference Signal Received Quality (RSRQ).
SI reception: In IDLE/INACTIVE state, configurations related to LP-WUS are provided through system information (SIB). Discussions are being conducted on whether a dedicated configuration is required and on activation/deactivation through a UE-specific signal.

The disclosed embodiment of the present disclosure intends to raise issues currently discussed in 3GPP regarding the entry/exit conditions among LP-WUR/WUS items and to propose ideas for resolving the issues.

According to the type of Internet-of-Things (IoT) devices (including mobile communication terminals), personal terminals require recharging daily or weekly depending on usage time. Generally, terminal devices consume tens of milliwatts in an inactive state and consume hundreds of milliwatts or more in an active state. Design or operational mechanisms closely related to battery life are essential factors for improving energy efficiency and enabling users or operators to receive high-quality services.

Energy efficiency is more critical for devices using small rechargeable batteries or coin cell batteries. Devices such as sensors are widely deployed for monitoring, measurement, inspection, and the like. Because the batteries of such devices (e.g., smart watches, smart rings, e-health devices, medical monitoring devices, etc.) may not be rechargeable or may operate in environments where frequent recharging is difficult, mechanisms for appropriate energy efficiency are required.

By using the above-described LP-WUS/WUR to trigger MR paging monitoring of a UE, it is expected to earn significant UE power-saving gain (up to more than 90%). Also, compared to existing eDRX operation, significant paging latency reduction and moderate UE power-saving gain are observed if LP-WUS monitoring and corresponding paging monitoring are performed after MR wake-up without being restricted within PTW of existing eDRX. In the UE active state, moderate UE power-saving gain (up to more than 10%) has been observed across various types of XR traffic and system load scenarios, compared to existing UE power-saving techniques, when the impact on the capacity is marginal by using LP-WUS/WUR to trigger UE MR PDCCH monitoring.

In order to efficiently use the LP-WUS/WUR method, which is evaluated as being highly effective in reducing battery power consumption, error-free operation must be guaranteed. In order for an IoT device (UE) to apply LP-WUS/WUR and switch to an ultra-sleep mode, an accurate LP-WUS monitoring entry condition (equal to or greater than a threshold) must be satisfied. Likewise, when an accurate LP-WUS monitoring exit condition (less than a threshold) is satisfied, the UE should stop LP-WUS monitoring, switch to a DRX mode, and transition to an operational state for data transmission and reception. The entry and exit conditions for applying the LP-WUS/WUR method are associated with setting appropriate cell coverage/range and thresholds.

In the current 3GPP TR 38.869 technical document (Study on low-power wake-up signal and receiver for NR) and submitted contributions, a UE is considered to be within LP-WUS coverage, that is, the LP-WUS entry condition is defined to be satisfied when the RSRP/RSRQ value of a Synchronization Signal Block (SSB) received by the MR is higher than a threshold or when the LP-SS quality introduced for LR measurement is higher than a predefined threshold.

The LP-WUS exit condition is defined to be satisfied when the UE moves out of the LP-WUS coverage, that is, when the RSRP/RSRQ value of the SSB received by the LR is lower than a threshold, and in this case, the UE should stop the LP-WUS operation, exit the ultralow-power state, and restart the MR. Applying a single threshold for the LP-WUS entry/exit conditions to all UEs in different environments is not appropriate when considering current complex cell environments and deployments. As a result, malfunctions (e.g., ping-pong situations) in entry and exit conditions are likely to occur, and the false detection rate may increase. Accordingly, discussions on defining multiple thresholds have continuously been conducted in 3GPP standard meetings.

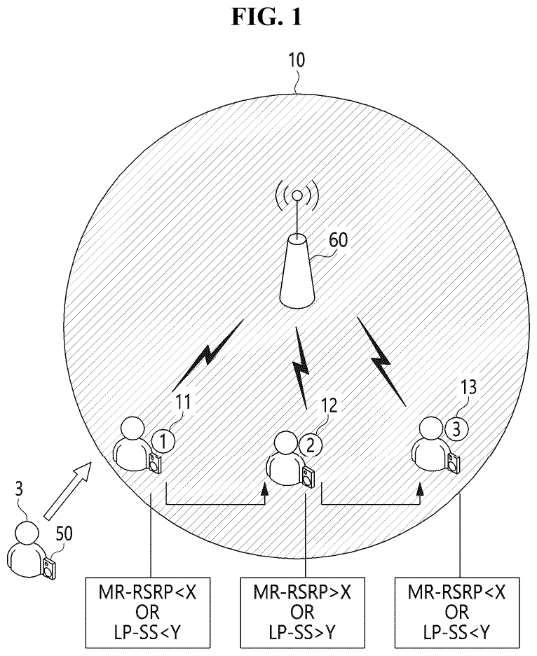

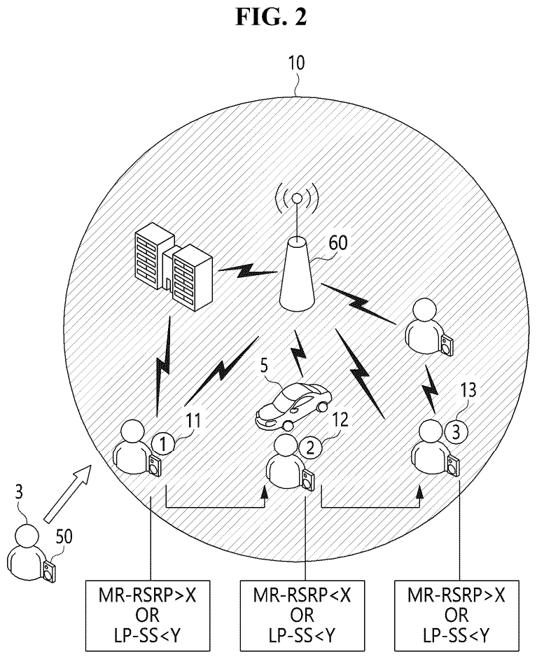

FIG. 1 is a view illustrating a normal LP-WUS entry/exit scenario according to an embodiment of the present disclosure, and FIG. 2 is a view illustrating an LP-WUS entry/exit scenario in which an error occurs according to an embodiment of the present disclosure. FIG. 1 shows an example of normal LP-WUS monitoring entry and exit, whereas FIG. 2 shows problems that may occur when LP-WUS entry and exit conditions are determined based on a single threshold. In FIGS. 1 and 2, one example is selected and illustrated, among sections of various Internet devices, but the present disclosure is not limited to the above-described scenario.

In the scenario illustrated in FIG. 1, a user 3 carrying a communication device 50 moves into a cell 10, and entry into and exit from LP-WUS monitoring are shown. When the communication device moves to state 1 (11), state 2 (12), and state 3 (13) in FIG. 1, the RSRP/RSRQ value transmitted from a network device 60 and measured by the Main Radio (MR) of the communication device 50 is compared with a threshold X, and the LP-SS measured by the communication device 50 is compared with a threshold Y, whereby whether the LP-WUS entry condition is satisfied may be determined. In the scenario of FIG. 1, the LP-WUS entry condition is not satisfied at point 1 (11), but the entry condition is satisfied at point 2 (12), so the communication device 50 transitions to an ultralow-power state. At point 3 (13), the communication device 50 exits from the LP-WUS state according to the LP-WUS exit condition. Table 1 below shows the LP-WUS operation of the communication device 50 and the operating state of a receiver according to LP-WUS stop and exit conditions. In some embodiments, the communication device 50 may be a user equipment (UE), and the network device 60 may be a base station.

TABLE 1
Operating state of UE according to IoT Device movement

| | Point 1 | Point 2 | Point 3 |
|---|---|---|---|
| LP-WUS state | OFF | ON | OFF |
| MR operating state | ON | OFF | ON |
| LR operating state | ON (optional) | ON | ON (optional) |

FIG. 2 illustrates a scenario in which an error may occur when a single threshold is used for an RSRP/RSRQ value or a single threshold is used for an LP-SS. FIG. 2 also represents one of various scenarios, and the present disclosure may be applied to various scenarios, without being limited to the scenario shown in FIG. 2. In addition, although a mobile device is described for easy understanding of the example, the present disclosure may be applied to all types of devices, including a stationary device and an intermittently or periodically mobile device.

The scenario illustrated in FIG. 2 shows the mobility of the communication device 50, similar to that of FIG. 1, but shows the occurrence of an opposite result. When the RSRP/RSRQ value temporarily exceeds the threshold at point 1 (11) due to unexpected radio wave refraction, the device transitions to an ultralow-power state because the LP-WUS condition is satisfied. However, when the radio wave refraction is temporary, the LP-WUS exit condition is satisfied, which causes the device to exit from the LP-WUS state. Frequent alternation of LP-WUS entry and exit conditions occurs due to the mobility of the communication device 50, which causes the battery of the device to be consumed. At point 2 (12), when the RSRP/RSRQ becomes less than the threshold due to temporary degradation resulting from obstruction by a vehicle 5 or a large object, weather conditions, or the like, repeated alternation of LP-WUS entry and exit conditions may occur. At point 3 (13), when a user 3 using a communication device 50, a vehicle 5, or other IoT equipment temporarily appears and acts as a radio relay, the RSRP/RSRQ value may temporarily exceed the threshold, again resulting in repeated alternation of LP-WUS entry and exit conditions. When LP-WUS entry/exit conditions are repeatedly and alternately satisfied (i.e., a ping-pong situation), repeated signaling procedures, repeated ON/OFF operations of a receiver, and repeated execution and termination of operations may increase not only battery consumption of the device but also overall network complexity. The disclosed embodiment of the present disclosure proposes a method for dynamically defining and managing threshold criteria for MR RSRP/RSRQ and LP-SS values in order to reduce malfunctions related to LP-WUS entry and exit conditions.

In order to reduce the power consumption of the communication device 50 and improve battery efficiency, it is necessary to maintain the ultralow-power state using the LP-WUS method. To this end, it is important to enter the LP-WUS state under accurate conditions, and in order to apply such accurate conditions, LP-WUS thresholds should be set in consideration of the device state, the state of the network device 60, the radio environment, weather conditions, surrounding objects, and the like. As described above, the current condition for entering the LP-WUS state is determined based on a single threshold. Such a single threshold does not consider diverse situations and may lead to repeated entry into and exit from the LP-WUS state (ping-pong) due to short-term unstable MR measurement caused by various factors such as frequently changing radio environments and device conditions and due to the device located at the boundary of LP-WUS coverage. Such a ping-pong situation not only does not contribute to reducing power consumption of the device but may also become a factor that further increase power consumption due to frequent signaling procedures and repeated ON/OFF operations of the receiver. In order to prevent repeated ping-pong situations caused by errors, the disclosed embodiment of the present disclosure dynamically sets a threshold for an LP-WUS entry condition such that thresholds optimized for various environments are used, thereby minimizing ping-pong situations caused by errors and reducing battery consumption of the device.

In the disclosed embodiment of the present disclosure, the proposed method for setting dynamic thresholds may comprise configuring virtual LP-WUS threshold zones within a single cell. Different thresholds may be set for the respective zones, and a communication device 50 attempting entry into LP-WUS monitoring in a single threshold zone may determine the entry through comparison with the threshold that is set for the corresponding zone. The method of configuring threshold zones within a single cell may be based on the location value of the communication device 50 reported by the communication device 50 and the corresponding RSRP/RSRQ values at the location. The network device 60 may construct a database (DB) for the location values and the RSRP/RSRQ values reported from the communication device 50 and may configure virtual LP-WUS threshold zones.

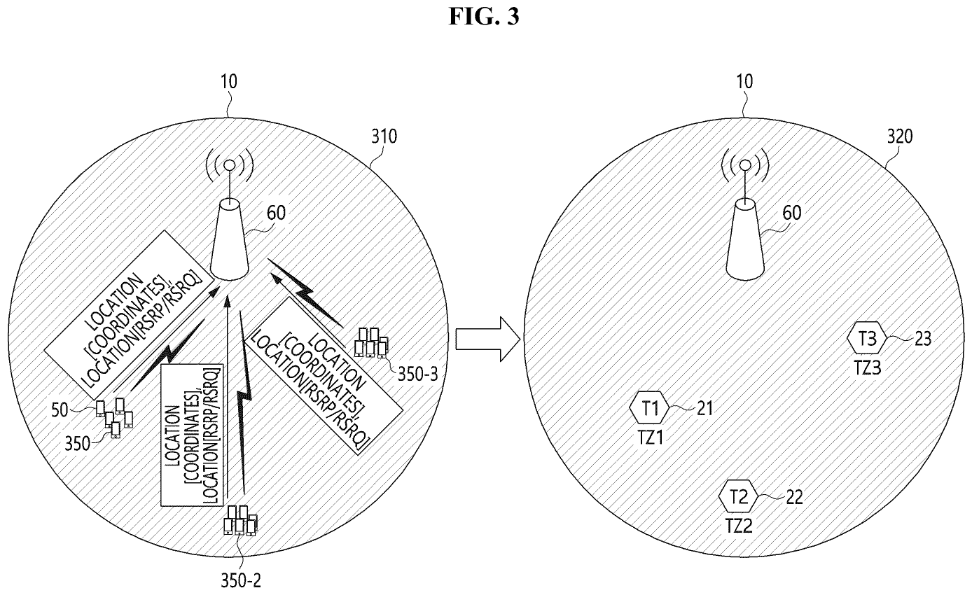

FIG. 3 is a view illustrating a method for generating LP-WUS threshold zones according to an embodiment of the present disclosure and shows a method of configuring LP-WUS threshold zones within each cell.

Referring to FIG. 3, when communication devices 50 located at similar locations within a single cell 10 enter the LP-WUS coverage area, they may transition to an ultralow-power state for receiving an LP-WUS. Here, the communication device 50 may store location information. Here, the location information may include location (coordinate information) of the communication device 50 or the RSRP/RSRQ value of the MR received at the corresponding location. In some embodiments, the communication device 50 may receive location information indicating the location thereof from a network device 60 or a location server. For example, according to the location service procedures defined in the 3GPP standards, location information of the communication device 50 calculated by the network device 60 or the location server may be transmitted to the communication device 50. In this case, the communication device 50 may use the location information provided from the network side as the location information indicating the location thereof. Also, the communication device 50 may receive location information or assistance information for location estimation through system information, an RRC message, or a location-service-related message, and the received information may be used for determining or generating location information.

In some embodiments, the communication device 50 may estimate the location thereof using measurement results of reference signals received from the network device 60. Specifically, the communication device 50 may perform measurement of a reference signal, a pilot signal, or a synchronization signal received from one or more network devices 60, and may estimate the location thereof based on the measurement results. The measurement results may include the strength (RSRP), the quality (RSRQ), the signal arrival time, or timing information of the signal, or a combination thereof measured by a main receiver (MR) or a low-power receiver (LR). Such measurement-based location estimation may include cell-based location estimation, relative location estimation among multiple cells, or location estimation within a specific region, and the communication device 50 may store the estimation result as location information indicating the location thereof.

In some embodiments, the communication device 50 may generate location information indicating the location thereof using its own location measuring means. For example, the communication device 50 may generate location information based on absolute coordinates using a Global Navigation Satellite System (GNSS) signal. Also, the communication device 50 may improve the accuracy or speed of location generation using location-related assistance data provided by the network device 60. Furthermore, the communication device 50 may generate location information reflecting the movement direction, the movement distance, or the relative location change using an acceleration sensor, a gyro sensor, or other sensor information. The location information generated as described above may be absolute coordinate information, relative location information, or information indicating a location within a specific zone or region, and the present disclosure is not limited thereto.

The stored location information may be transmitted at the timing at which the communication device 50 can transmit uplink (UL) data to the current network device 60. For example, the communication device 50 may transmit the stored location information at the earliest timing among various uplink (UL) data transmission opportunities, such as SI update, emergency message reception, RRC release, and the like. Based on the location information transmitted from the communication device 50, the network device 60 may generate virtual LP-WUS threshold zones 21, 22, and 23.

The example in the left image 310 of FIG. 3 shows that three communication device groups 350, 350-2, and 350-3 transmit location information to the network device 60, and the right image 320 of FIG. 3 shows that the network device 60 generates three LP-WUS threshold zones 21, 22, and 23 based on the location information. Because three zones TZ1, TZ2, and TZ3 are present and they have different thresholds T1, T2, and T3, when the communication device 50 enters each zone, it may transition to an ultralow-power state for receiving an LP-WUS based on the different thresholds. Accordingly, the network device 60 may configure virtual zones and dynamically define different thresholds for the respective zones.

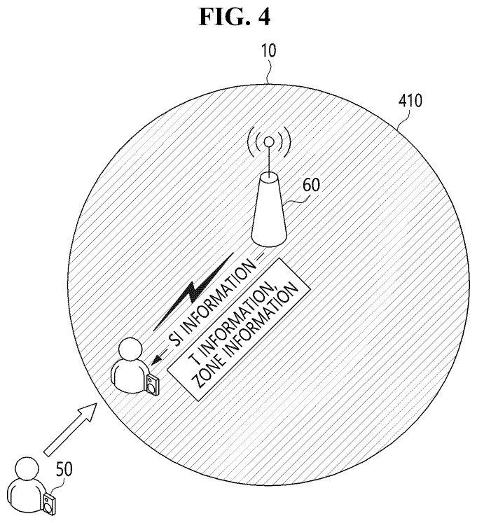

FIG. 4 is a view illustrating location information transmission between a network device and a communication device according to an embodiment of the present disclosure, and shows a method of transmitting location information to the communication device.

Referring to FIG. 4, when the communication device 50 moves from outside to inside the coverage area of a cell 10, system information (SI) of the corresponding cell 10 may be transmitted to the communication device 50. Here, the network device 60 may transmit information about LP-WUS threshold zones within the cell 10 and threshold information corresponding to each LP-WUS threshold zone to the communication device 50.

In an embodiment of the present disclosure, the information about the LP-WUS threshold zones may refer to information about one or more spatial regions defined such that a user equipment (UE) can determine whether to enter, remain in, or exit LP-WUS monitoring according to the location thereof. The information about the LP-WUS threshold zones may be defined in plural within a single cell, and each LP-WUS threshold zone may be associated with different threshold information.

The information about the LP-WUS threshold zones may include zone identification information for identifying each zone and information indicating the location or region in which the corresponding zone is formed. Here, the information indicating the location or region of the zone may include at least one of absolute coordinates, a cell-based relative location, a center point and radius of the zone, or polygonal boundary information, or a combination thereof, and the present disclosure is not limited thereto.

Meanwhile, the threshold information is a value that is set to correspond to the LP-WUS threshold zone and may provide a criterion for determining whether a UE should enter or exit LP-WUS monitoring within the corresponding zone. The threshold information may include at least one of an LP-WUS entry threshold for a signal measured by a main receiver (MR), or an LP-WUS exit threshold for a signal measured by a low-power receiver (LR), or a combination thereof. Specifically, the threshold information may include reference values for received signal strength (RSRP), received signal quality (RSRQ), timing information, or a combination thereof, and the reference values may be differently set for each LP-WUS threshold zone. Accordingly, even within the same cell, the UE may apply different thresholds depending on the LP-WUS threshold zone to which it belongs. Also, the threshold information may include both a first threshold for entry into LP-WUS monitoring and a second threshold for exit from the LP-WUS monitoring, and a hysteresis may be set between the entry threshold and the exit threshold. Accordingly, a ping-pong situation in which entry into and exit from LP-WUS monitoring are repeatedly triggered due to the mobility of the UE or fluctuations in the radio environment may be mitigated.

In some embodiments, the information about the LP-WUS threshold zones and the threshold information may be configured or updated by the network device 60, and may be transmitted to the UE through system information, an RRC message, or a control signal corresponding thereto. The communication device 50 may autonomously determine whether to enter or exit LP-WUS monitoring by comparing the received LP-WUS threshold zone information and threshold information with its location information and radio measurement value.

The communication device 50 may determine the LP-WUS threshold zone based on location information received from the network device 60 or location information generated by itself, and may determine whether to enter LP-WUS monitoring based on the threshold according to the situation. Because the mechanism for setting dynamic thresholds reflects various radio environments and network environments, the mechanism may be performed primarily by the communication device 50, rather than by the network device 60 or a core network entity, and based on location information reported by the communication device 50, the LP-WUS threshold zone and the threshold optimized for the communication device 50 may be dynamically and periodically configured. The method of setting a threshold based on location information reported by each communication device 50 and the period for setting the threshold are not currently discussed as key factors in the 3GPP Work Item (WI), so these are limited to implementation issues for efficient and appropriate settings in the network device 60 and are not discussed in the disclosed embodiment of the present disclosure.

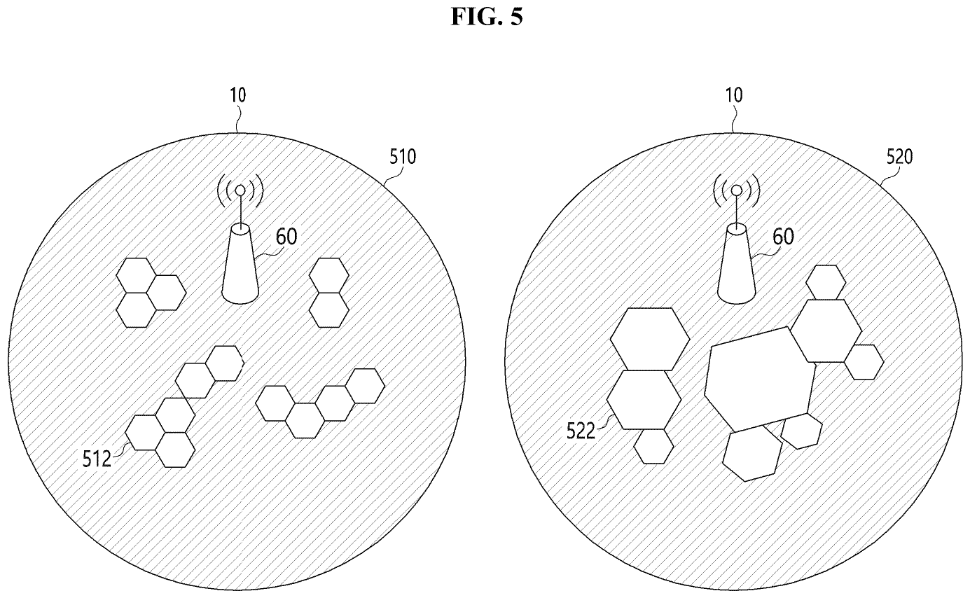

FIG. 5 is a view illustrating a uniform method and a non-uniform method for configuring LP-WUS threshold zones according to an embodiment of the present disclosure, and schematically illustrates zone areas that may appear when applying the LP-WUS threshold zone uniform method and non-uniform method.

Referring to FIG. 5, the proposed method relates to generating LP-WUS threshold zones, and the method includes a uniform method 510 and a non-uniform method 520.

In the uniform method 510, the size of an LP-WUS threshold zone 512 is defined as a single fixed size, and zones having the predefined size are allocated when generating LP-WUS threshold zones. In the uniform method 510, the network device 60 may allocate one or more zones 512 according to the predefined size, regardless of the range of the communication devices 50 performing reporting.

The non-uniform method 520 does not predefine the size of an LP-WUS threshold zone 522, defines the size of the zone 522 according to the range of the communication device 50 performing reporting, and generates the defined zone 522. In the non-uniform method 520, the range of the communication device 50 performing reporting is defined as the minimum zone size proposed in the uniform method 510, and the network device 60 may generate a zone having a size capable of sufficiently covering a wider range.

In the uniform method 510, zones 512 having a fixed size are allocated, which enables simple and straightforward arrangement and has advantages of clear zone boundaries and a low possibility of overlapping zone areas. However, as the number of generated zones increases, the management load may increase, and the amount of data transmitted to the communication device 50 may also increase.

In contrast, in the non-uniform method 520, zones are generated with sizes that are determined depending on the range of the communication devices 50 reporting the location information. Accordingly, the larger the zone area, the less the number of zones to be managed, and the management load and the amount of data transmitted to the communication device 50 may be reduced. However, the non-uniform method 520 may increase the complexity of calculating the zones 522, may result in overlapping areas between the zones 522, and may cause zone holes in hotspot areas.

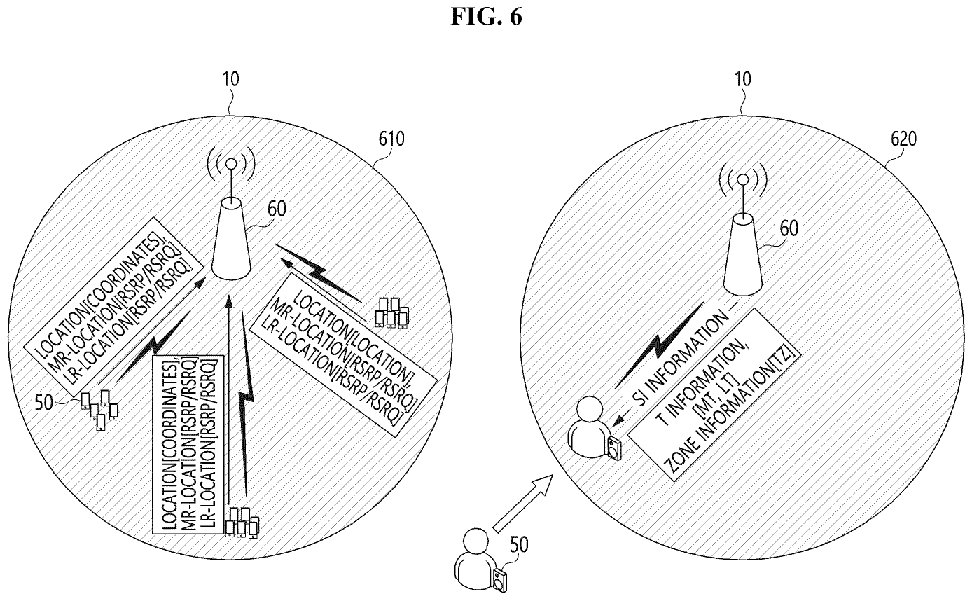

FIG. 6 is a view illustrating a method of defining a dynamic threshold for an LP-WUS exit condition according to an embodiment of the present disclosure.

Referring to FIG. 6, the method of defining a dynamic threshold for the LP-WUS exit condition may follow a method of defining a dynamic threshold for the LP-WUS entry condition. The left image 610 of FIG. 6 shows that a communication device 50 transmits data to a network device 60, similar to that shown in the left image 310 of FIG. 3, and shows that the communication device 50 transmits LR information in addition to the data described as being transmitted in FIG. 3. Here, the location information transmitted from the communication device 50 to the network device 60 may include LR information. That is, the location information may include a location value corresponding to the LP-WUS entry condition, the RSRP/RSRQ value of an MR for the location value, a location value corresponding to the LP-WUS exit condition, and the LP-SS RSRP/RSRQ value of an LR for the location value.

The network device 60 may construct a database (DB) for a location value and MR/LR RSRP/RSRQ values reported from the communication device 50 when the LP-WUS entry and exit events are triggered, and may configure virtual LP-WUS threshold zones. Here, the network device 60 may configure the LP-WUS threshold zones by reflecting both an MR threshold and an LR threshold.

The right image 620 of FIG. 6 shows that, when the communication device 50 crosses a cell boundary from outside to inside, system information (SI) is transmitted to the communication device 50, similar to that shown in the image 410 of FIG. 4. In FIG. 6, the network device 60 may transmit threshold information (T information), including a threshold (MT) for the MR and a threshold (LT) for the LR, and zone information to the communication device 50, in addition to the information described as being transmitted in FIG. 4. Based on the corresponding information, the communication device 50 may perform entry and exit operations, that is, start and stop LP-WUS monitoring, based on the MT and LT of each LP-WUS zone.

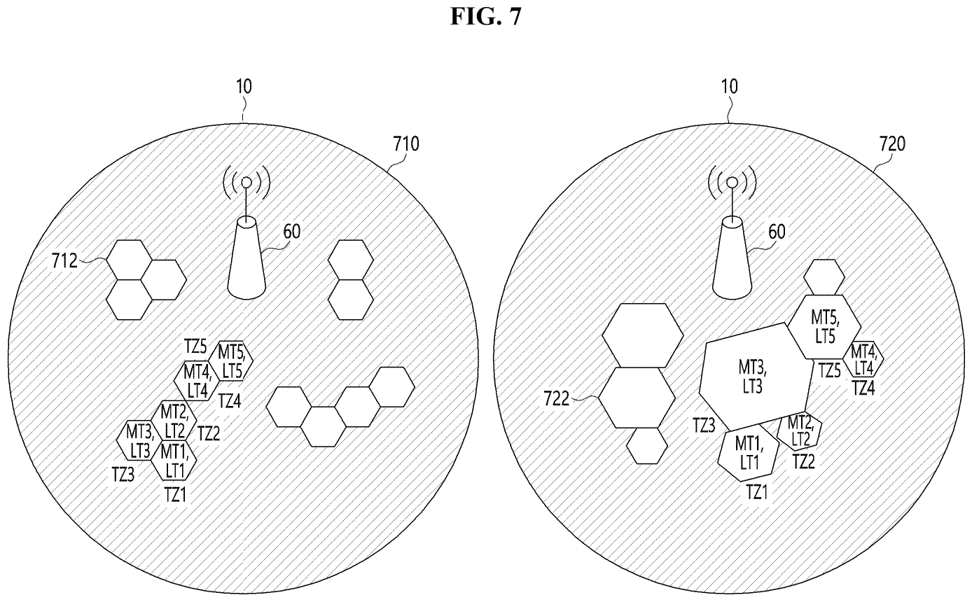

FIG. 7 is a view illustrating a uniform method and a non-uniform method for configuring threshold zones based on LP-WUS entry and exit conditions according to an embodiment of the present disclosure, and shows a uniform method and a non-uniform method for configuring LP-WUS threshold zones based on a method of defining dynamic thresholds for LP-WUS entry and exit conditions.

Referring to FIG. 7, the left image 710 represents the uniform method, in which zones 712 having an identical size are formed and in which each zone is configured with an MT and an LT different from those of other zones. Also, the right image 720 shows that zones 722 having different sizes are formed and that each zone is configured with an MT and an LT different from those of other zones.

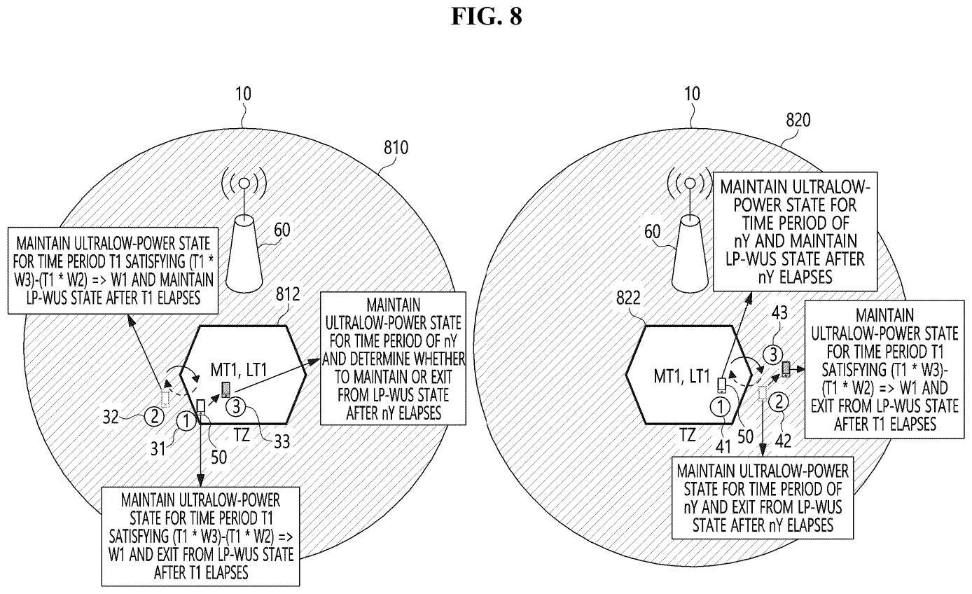

FIG. 8 is a view illustrating an LP-WUS entry and exit ping-pong situation and a method for solving the ping-pong situation according to an embodiment of the present disclosure and shows methods for handling an LP-WUS entry situation and an LP-WUS exit situation in order to resolve the ping-pong situation. The situation illustrated in FIG. 8 includes a situation occurring at a cell boundary and part of a ping-pong situation caused by unstable MR/LR measurements, and the present disclosure is not limited to the example shown in FIG. 8.

Referring to FIG. 8, a ping-pong problem may occur due to LP-WUS zone boundaries or unstable MR/LR measurements. The ping-pong problem occurring at LP-WUS zone boundaries may be caused due to the mobility of the communication device 50. Even when not located at an LP-WUS zone boundary, if unstable MR or LR measurements frequently occur at a particular spot, entry into and exit from LP-WUS monitoring may be repeated, resulting in a ping-pong situation in which entry into and exit from LP-WUS monitoring are repeated. In the disclosed embodiments of the present disclosure, a method for resolving such a ping-pong situation is proposed by dividing the situation into two cases: entry into LP-WUS monitoring and exit from LP-WUS monitoring.

Upon entry into LP-WUS monitoring and under unstable MR/LR reception conditions, if the LP-WUS entry condition is satisfied, the communication device 50 may enter LP-WUS monitoring and transition to an ultralow-power state. Even if an LP-WUS exit condition is satisfied after entry, the communication device 50 maintains the ultralow-power state for a preset time period X. After the preset time period X expires, whether the LP-WUS exit condition is satisfied is determined, and whether to maintain or terminate the LP-WUS state is determined.

In an embodiment of the present disclosure, the preset time period X may be calculated based on the following Method 1:

### [Method 1]

T1 is defined as the preset time period X that satisfies the condition (T1×W3)−(T1×W2)≥W1.

Here, W1 is the total power consumption of the communication device from LP-WUS entry to immediate exit, W2 is the power consumption of the communication device per unit time during T1 after LP-WUS entry, and W3 is the power consumption of the communication device per unit time during T1 after entry into LP-WUS eDRX/DRX.

In other words, X is determined by comparing the energy consumed due to the ping-pong situation with the power gain obtained after entry into LP-WUS monitoring, maintaining the LP-WUS state until the power gain is equal to or greater than the consumed energy, and then applying the LP-WUS exit condition. In the disclosed embodiment of the present disclosure, the preset time period X is calculated in consideration of energy consumption, but without limitation thereto, a method of calculating the preset time period X in consideration of various factors including other energy-related metrics may be included in the scope of the present disclosure.

In the event of an LP-WUS exit condition, if the communication device 50 is located within an LP-WUS zone or at the boundary of the LP-WUS zone, when the LP-WUS exit condition is satisfied (e.g., the communication device 50 is outside the LP-WUS zone or the RSRP/RSRQ of the LP-SS is less than a threshold, that is, there is a high probability of ping-ponging), the communication device 50 may maintain the ultralow-power state during Y*n (where n is a positive integer and Y is the eDRX/DRX cycle configured in the communication device 50), rather than immediately performing the LP-WUS exit procedure. Here, n starts from 1, and the number of cycles for which the delay is applied may be determined based on the value of n. The value of n may be defined by a developer or administrator depending on the situation. After the delay of nY, the LP-WUS exit condition is determined, and the ultralow-power state may be maintained or LP-WUS monitoring may be terminated.

In the left image 810, first, when the communication device 50 moves from location 1 (31) to location 2 (32) and then back to location 1 (31), that is, when the communication device 50 in the LP-WUS state is temporarily out of the zone 812 and re-enters the zone, the communication device 50 may operate according to the condition of location 1 (31) (maintain the ultralow-power state for a period of T1 that meets (T1×W3)−(T1×W2)≥W1, and continue to stay in the LP-WUS state after T1 elapses). Also, when the communication device 50 moves from location 1 (31) to location 2 (32), the communication device 50 may operate according to the condition of location 2 (32) (maintain the ultralow-power state for a period of T1 that meets (T1×W3)−(T1×W2)≥W1, and terminates LP-WUS monitoring after T1 elapses). Also, when the communication device 50 moves from location 1 (31) to location 3 (33), if an LP-WUS exit condition is satisfied due to unstable MR/LR reception states, the communication device 50 may operate according to the condition of location 3 (33) (maintain the ultralow-power state for a period of nY, and determine whether to maintain or exit from the LP-WUS state after nY elapses).

In the right image 820, if the communication device 50 moves from location 1 (41) to location 2 (42) and then back to location 1 (41), although the communication device 50 satisfies the LP-WUS exit condition at location 2 (42), the communication device 50 may operate according to the condition of location 1 (41) (maintain the ultralow-power state for a period of nY, and maintain the LP-WUS state after nY elapses) upon returning to location 1 (41). Also, when the communication device 50 moves from location 1 (41) to location 2 (42), the communication device 50 may operate according to the condition of location 2 (42) (maintain the ultralow-power state for a period of nY, and terminate LP-WUS monitoring after nY elapses). Also, if the communication device 50 satisfies the LP-WUS entry condition due to unstable MR/LR reception states when it moves to location 3 (43) after the communication device 50 stops LP-WUS monitoring by moving from location 1 (41) to location 2 (42), the communication device 50 may operate according to the condition of location 3 (43) (maintain the ultralow-power state for a period of T1 that meets (T1×W3)−(T1×W2)≥W1, and exits from the LP-WUS state after T1 elapses). In scenarios that may trigger an LP-WUS entry and exit ping-pong situation, application of the procedures proposed in the disclosed embodiment of the present disclosure may prevent a ping-pong situation, and even in the event of a ping-pong situation, power consumption caused by the ping-pong situation may be minimized and power efficiency may be maximized.

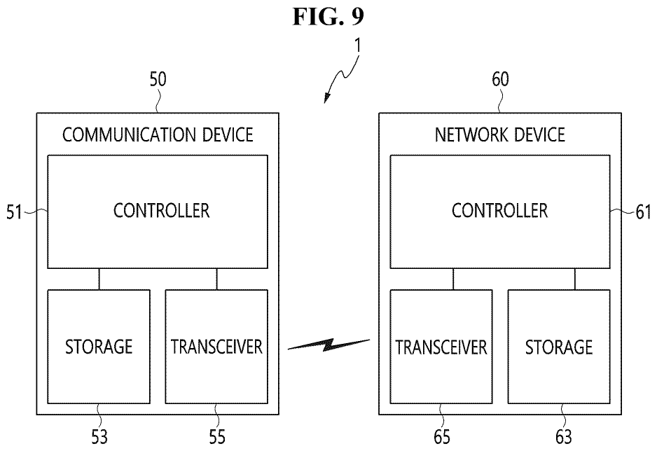

FIG. 9 is a block diagram illustrating the configuration of an ultralow-power system for improving energy efficiency of a communication device in a wireless environment according to an embodiment of the present disclosure.

Referring to FIG. 9, a communication system 1 according to the present disclosure may include at least one communication device 50 and a network device 60. The communication device 50 and the network device 60 may perform various functions to implement the schemes, techniques, processes, and methods described in the present disclosure in relation to LP-WUS transmission and LP-WUS monitoring entry and exit in mobile communication, and these are associated with the various designs, concepts, schemes, and methods proposed above, the scenarios/schemes described for user equipment and a network device of mobile communication, and the methods described with reference to FIGS. 1 to 8. The communication device 50 and the network device 60 may be ultralow-power apparatuses for improving energy efficiency of communication devices in a wireless environment.

The communication device 50 may include an Internet-of-Things (IoT) device or a mobile communication terminal.

Also, the communication device 50 may be part of an electronic device, and the electronic device may be a UE, which is a portable or mobile device, a wearable device, a wireless communication device, or a computing device. For example, the communication device 50 may be implemented in a smartphone, a smartwatch, a personal digital assistant (PDA), a digital camera, or a computing device such as a tablet computer, a laptop computer, or a notebook computer. The communication device 50 may also be part of a machine-type device, and it may be an IoT, NB-IoT, or IIoT device, which may be a fixed or stationary device, a home appliance, a wired communication device, or a computing device. For example, the communication device 50 may be implemented in a smart thermostat, a smart refrigerator, a smart door lock, a wireless speaker, or a home control center. Alternatively, the communication device 50 may be implemented in the form of one or more integrated circuit (IC) chips, and may be, for example, one or more single-core processors, one or more multi-core processors, one or more reduced instruction set computer (RISC) processors, or one or more complex instruction set computer (CISC) processors without limitation. The communication device 50 may include at least part of the components illustrated in FIG. 9 (e.g., a controller 51). The communication device 50 may further include one or more additional components not related to the proposed schemes of the present disclosure (e.g., an internal power supply device, a display device, and/or a user interface device), and these are not illustrated in FIG. 9 for simplicity and conciseness and will not be described below.

The network device 60 may be part of a network device, which may be a network node such as a satellite, a base station, a small cell, a router, or a gateway. For example, the network device 60 may be implemented as an eNodeB of an LTE network, a gNB of a 5G/NR, IoT, NB-IoT, or IIoT network, or a satellite or base station of a 6G network. Alternatively, the network device 60 may be implemented in the form of one or more IC chips, and may be, for example, one or more single-core processors, one or more multi-core processors, or one or more RISC or CISC processors without limitation. The network device 60 may include at least part of the components illustrated in FIG. 9 (e.g., a controller 61). The network device 60 may further include one or more additional components not related to the proposed schemes of the present disclosure (e.g., an internal power supply device, a display device, and/or a user interface device), and these are not illustrated in FIG. 9 for simplicity and conciseness and will not be described below.

In some embodiments, each of the controller 51 and the controller 61 may be implemented as one or more single-core processors, one or more multi-core processors, or one or more CISC processors. In another aspect, each of the controller 51 and the controller 61 may be implemented in the form of hardware (and optionally firmware), including electronic components (e.g., one or more transistors, one or more diodes, one or more capacitors, one or more resistors, one or more inductors, one or more memristors, and/or one or more varactors without limitation) configured and arranged to achieve a specific purpose. In other words, in at least some implementations, each of the controller 51 and the controller 61 may be a special-purpose machine specifically designed, arranged, and configured to perform autonomous reliability improvement in a device (e.g., the communication device 50) and a network (e.g., the network device 60) according to various implementations of the present disclosure.

In some embodiments, the communication device 50 may include a transceiver 55 connected to the controller 51 and configured to wirelessly transmit and receive data. In some implementations, the transceiver 55 may include a main transceiver (e.g., the above-described MR receiver) or an LP-WUS transceiver (e.g., the above-described LP receiver). In some implementations, the communication device 50 may further include storage 53 connected to the controller 51 and accessible by the controller 51 for storing data.

In some embodiments, the network device 60 may also include a transceiver 65 connected to the controller 61 and configured to wirelessly transmit and receive data. In some implementations, the network device 60 may further include storage 63 accessible by the controller 61 for storing data. Accordingly, the communication device 50 and the network device 60 may wirelessly communicate with each other via the transceiver 55 and the transceiver 65, respectively. For ease of understanding, the following description of operations, functions, and capabilities of the communication device 50 and the network device 60 may be provided in the context of a mobile communication environment in which the communication device 50 is implemented as a UE or a communication device and the network device 60 is implemented as a network node or base station of a communication network.

In some embodiments, the controller 51 may receive a WUS configuration from a base station 60 through the transceiver 55. The controller 51 may monitor a wake-up signal based on the WUS configuration. In some implementations, the wake-up signal may be associated with at least one of a UE group ID, an LP-WUS subgroup ID, cell information, time information, or System Frame Number (SFN) information, or a combination thereof.

In some implementations, when the main transceiver of the transceiver 55 is in a power-saving mode, the controller 51 may perform synchronization through the LP-WUS transceiver of the transceiver 55. In some implementations, the controller 51 may perform synchronization based on a Synchronization Signal Block (SSB) or Physical Broadcast Channel (PBCH) block via the LP-WUS transceiver of the transceiver 55. In some implementations, the controller 51 may perform synchronization based on an LP-SS via the LP-WUS transceiver of the transceiver 55. In some implementations, the LP-SS periodicity may include at least one of 320 ms, 640 ms, 1280 ms, 2560 ms, 5120 ms, or 10240 ms, or a combination thereof. In some implementations, the LP-SS may include an LP-WUS preamble.

In some implementations, the controller 51 may determine whether the communication device 50 remains in the same cell. The controller 51 may determine whether to wake up the main transceiver of the transceiver 55 based on whether the communication device 50 remains in the same cell and based on a wake-up signal.

In some implementations, the controller 61 may transmit a WUS configuration to the communication device 50 via the transceiver 65. The controller 61 may transmit a wake-up signal to the communication device 50 via the transceiver 65 based on the WUS configuration.

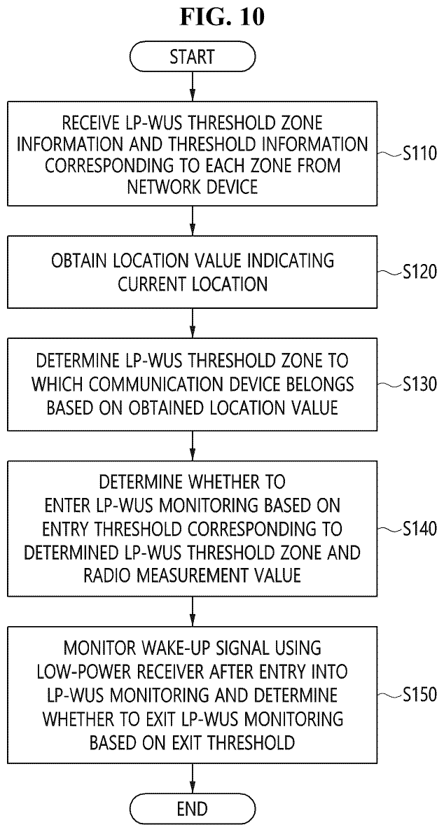

FIG. 10 is a flowchart illustrating a process of a wireless communication method performed by a communication device in order to implement an ultralow-power method for improving energy efficiency of a communication device in a wireless environment according to an embodiment of the present disclosure.

Referring to FIG. 10, when the communication device 50 enters the coverage area of a cell or is located within the cell, the communication device 50 receives information about one or more Low-Power Wake-Up Signal (LP-WUS) threshold zones and threshold information corresponding to each LP-WUS threshold zone from the network device 60 at step S110. Here, the information about the LP-WUS threshold zones may include zone identification information for identifying a plurality of zones and information indicating a spatial range of each zone, and the threshold information corresponding to each zone may include an entry threshold for entry into LP-WUS monitoring and an exit threshold for exit from LP-WUS monitoring. This information may be received through system information or through a control signal exchanged with the network device 60.

The communication device 50 acquires a location value indicating the current location thereof at step S120. The location value may be obtained based on location-related information received from the network device 60 or may be estimated or generated by the communication device 50 itself. For example, the communication device 50 may estimate the location thereof using Reference Signal Received Power (RSRP), Reference Signal Received quality (RSRQ), timing information, or a combination thereof measured through a main receiver (MR) or a low-power receiver (LR), and may generate the location value using a Global Navigation Satellite System (GNSS) signal, location-related assistance information, or sensor information provided in the communication device 50.

Based on the obtained location value, the communication device 50 determines at step S130 whether it belongs to any one of the one or more LP-WUS threshold zones about which information is received from the network device 60. Here, the communication device 50 compares the location value with the spatial range of each LP-WUS threshold zone, thereby determining the LP-WUS threshold zone including the current location. When a plurality of LP-WUS threshold zones are present, the zones may have identical or different sizes, and the communication device 50 may select a single zone corresponding to the location thereof.

The communication device 50 compares an LP-WUS entry threshold included in the threshold information corresponding to the determined LP-WUS threshold zone with a radio measurement value measured at the current location, thereby determining whether to enter LP-WUS monitoring at step S140. The radio measurement value may include Reference Signal Received Power (RSRP), Reference Signal Received Quality (RSRQ), timing information, or a combination thereof measured via the main receiver (MR) or the low-power receiver (LR), and when the radio measurement value satisfies the LP-WUS entry threshold, the communication device 50 may be controlled to enter LP-WUS monitoring.

After entry into LP-WUS monitoring, the communication device 50 maintains a low-power state while monitoring a wake-up signal using the low-power receiver (LR) at step S150. In this process, the communication device 50 may perform periodic or event-driven radio measurement, and may determine whether to exit from LP-WUS monitoring by comparing the measured radio measurement value with the LP-WUS exit threshold corresponding to the LP-WUS threshold zone.

In some embodiments, even when it is determined at step S150 that the LP-WUS exit condition is temporarily satisfied, the communication device 50 may maintain the LP-WUS state for a predefined time period before determining whether to exit from LP-WUS monitoring. The predefined time period may be calculated by comparing energy consumed due to entry into and exit from LP-WUS monitoring with energy gain obtained by maintaining the LP-WUS state. For example, the predefined time period may be calculated based on total power consumption from entry into LP-WUS monitoring to immediate exit, power consumption per unit time while maintaining LP-WUS monitoring, and power consumption per unit time in an eDRX or DRX state.

In some embodiments, the communication device 50 may also transmit first location information, including the location value thereof and a radio measurement value measured at the corresponding location, to the network device 60.

In some embodiments, the communication device 50 may transmit second location information, including a second location value indicating the location thereof after entry into LP-WUS monitoring and a second radio measurement value corresponding to the second location value, to the network device 60, and the second radio measurement value may include the RSRP/RSRQ value of an LP-SS received via the low-power receiver (LR) and the RSRP/RSRQ value of the main receiver (MR) for the location value when the LP-WUS exit condition is satisfied.

The network device 60 may generate or update the LP-WUS threshold zones or threshold information corresponding to each zone based on the transmitted first location information and second location information, and as a result, more appropriate LP-WUS monitoring entry and exit control may be performed for the communication device 50.

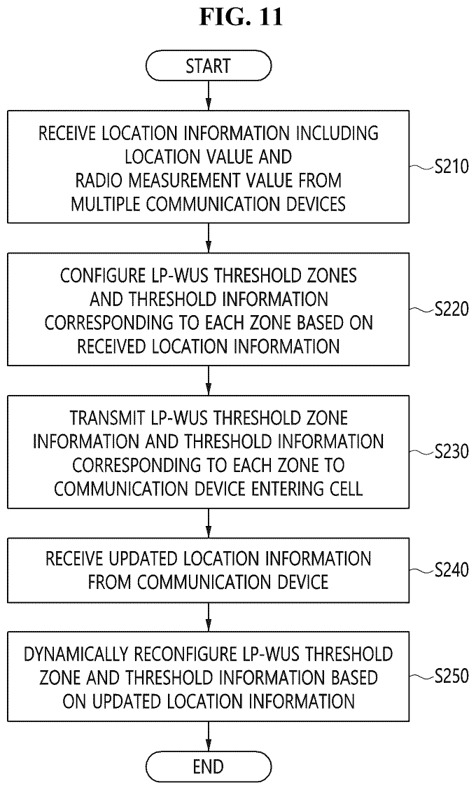

FIG. 11 is a flowchart illustrating a process of a wireless communication method performed by a network device in order to implement an ultralow-power method for improving energy efficiency of a communication device in a wireless environment according to an embodiment of the present disclosure.

Referring to FIG. 11, the network device 60 receives location information from a plurality of communication devices 50 located within a cell managed by the network device 60 or communication devices 50 entering the coverage area of the cell at step S210. The location information may include a location value indicating the location of the communication device 50 and a radio measurement value measured at the corresponding location, and the radio measurement value may include Reference Signal Received Power (RSRP), Reference Signal Received Quality (RSRQ), timing information, or a combination thereof measured through a main receiver (MR) or a low-power receiver (LR). The location information may be reported at a time at which the communication device 50 can transmit uplink (UL) data.

In some embodiments, at step S210, the network device 60 may collect and store the pieces of location information received from the communication devices 50 and may construct a database based on the location information. Here, the network device 60 may identify a region in which the communication devices 50 are densely located or a region having similar radio characteristics by comprehensively considering the distribution of location values reported from the plurality of communication devices 50, the distribution of radio measurement values, mobility characteristics of the communication devices 50, and radio environment characteristics.

Based on the identified region, the network device 60 configures one or more virtual Low-Power Wake-Up Signal (LP-WUS) threshold zones within the cell at step S220. The LP-WUS threshold zones may be uniform zones configured to have identical sizes or non-uniform zones configured to have different sizes according to the distribution range of the communication devices 50 and the radio environment. The LP-WUS threshold zones may be configured not to overlap each other, but may be configured to partially overlap each other in some embodiments.

At step S220, the network device 60 may set threshold information corresponding to each LP-WUS threshold zone. The threshold information may include an entry threshold for entry into LP-WUS monitoring and an exit threshold for exit from LP-WUS monitoring, and may be differently configured for each zone in consideration of the radio environment of the zone, the mobility of the communication devices 50, service characteristics, and energy efficiency requirements. In some embodiments, the network device 60 may establish hysteresis by configuring different entry and exit thresholds.

The network device 60 transmits information about the configured one or more LP-WUS threshold zones and the threshold information corresponding to each LP-WUS threshold zone to the communication device 50 at step S230. The transmission may be performed through system information when the communication device 50 moves from outside to inside the coverage area of the cell, or may be transmitted to the communication device 50 located within the cell through a separate control signal.

The network device 60 receives updated location information that is additionally reported from the communication device 50 located within the cell at step S240. The updated location information may be reported due to movement of the communication device 50, changes in the radio environment, or LP-WUS monitoring entry and exit events, and the network device 60 may reflect the updated location information in the existing database.

The network device 60 dynamically reconfigures the previously configured LP-WUS threshold zones or the threshold information corresponding to each zone based on the updated location information at step S250. For example, when a region in which the communication devices 50 are densely located changes or a new hotspot region is formed, the network device 60 may adjust the size, location, or number of LP-WUS threshold zones or may update the threshold corresponding to each zone. Through such processes, the network device 60 may adaptively respond to the distribution of communication devices 50 located within the cell and changes in the radio environment and efficiently control LP-WUS monitoring entry and exit operations of the communication devices 50, thereby improving overall energy efficiency and system performance of the cell.

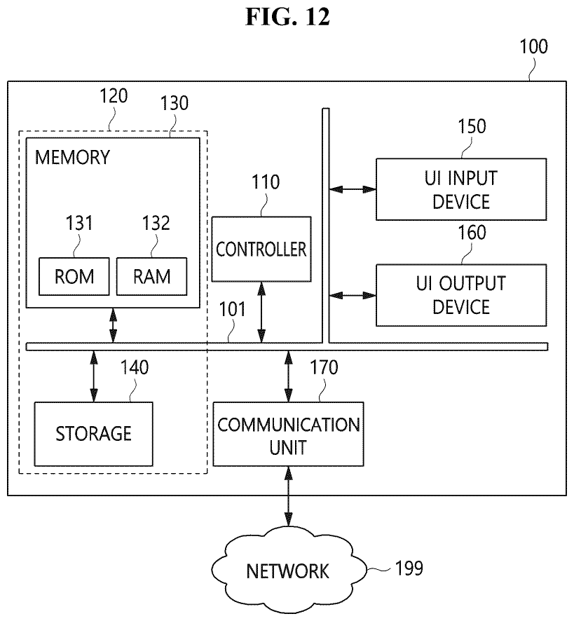

FIG. 12 is a view illustrating the configuration of a computer system according to an embodiment of the present disclosure.

Referring to FIG. 12, the communication device 50 may be implemented as a computer system 100. The computer system 100 may include a bus 101, a controller 110, storage 120, a user interface (UI) input device 150, a UI output device 160, and a communication unit 170. The storage 120 may include at least one of memory 130, or storage 140, or a combination thereof. The controller 110, the memory 130, the storage 140, the UI input device 150, the UI output device 160, and the communication unit 170 may communicate with each other via the bus 101.

When the communication device 50 is implemented as the computer system 100, the controller 110 may include the controller 51, the communication unit 170 may include the transceiver 55, and the storage 120 may include the storage 53.

The controller 110 may be a semiconductor device for executing processing instructions stored in the storage 120. The controller 110 may be at least one hardware processor. The controller 110 may be configured with one or more cores and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like.

The controller 110 may read a computer program stored in the storage 120 and perform data processing for training a deep-learning network according to an embodiment of the present disclosure.

Program modules may be configured with instructions or code executed by at least one processor of the controller 110. The program modules may be included in the computer system 100 in the form of operating systems, application modules, and other program modules. The program modules may be physically stored on various known memory devices. Also, at least part of the program modules may be stored in a remote memory device that can communicate with the communication unit 170.

The controller 110 may execute instructions or code of the parts, units, and modules described in the embodiments.

The storage 140 may be storage media including at least one of a nonvolatile medium, a detachable medium, a non-detachable medium, a communication medium, or an information delivery medium, or a combination thereof.

The memory 130 may include ROM 131 or RAM 132.

The communication unit 170 may transmit and receive data to and from other network entities over a network 199. Here, the network 199 may be a broadcast network, a private network, or an Internet network, and may include a wired network or a wireless network. The network 199 may indicate one or more portions of a network that may be an ad-hoc network, an intranet, an extranet, Bluetooth, ZigBee, a Virtual Private Network (VPN), a Local Area Network (LAN), a Wireless LAN (IEEE 802.11b, IEEE 802.11a, IEEE 802.11g, IEEE 802.11n), a Wireless Broadband (WiBro), a Wide Area Network (WAN), a wireless WAN (WWAN), a Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, another type of network, or a combination of two or more of these networks, and may indicate one or more portions of a network connected to another type of network. For example, the network or a portion thereof may include a wireless or cellular network, and the connection may be a Code Division Multiple Access (CDMA) connection, a Global System for Mobile communications (GSM) connection, or another type of cellular or wireless connection. In such an example, the connection may be implemented by any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standards, others technologies defined by various standard establishing organizations, other long-distance protocols, or other data transmission technologies.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

The ultralow-power method and apparatus for improving energy efficiency of a communication device in a wireless environment according to the present disclosure defines thresholds in consideration of characteristics of various cell environments through a method of dynamically defining thresholds for LP-WUS entry/exit conditions, so that a large number of devices existing in a cell can transition to an ultralow-power state by activating LP-WUS monitoring, thereby improving battery efficiency. Accordingly, the present disclosure may solve a problem in which a large number of IoT devices are not allowed to transition to an ultralow-power state due to conventional uniform thresholds used for LP-WUS entry/exit conditions without considering different environments of respective cells and characteristics of various IoT devices in the cells.

Also, in order to solve a ping-pong problem caused by an LP-WUS boundary region and unstable MR/LR reception, the present disclosure proposes a preset delay time before determining LP-WUS entry/exit conditions and determines the LP-WUS entry/exit conditions after the proposed delay time, thereby reducing battery consumption during the proposed delay time. Also, the present disclosure provides a method capable of minimizing the number of ping-pong occurrences, thereby reducing repetition of ping-pong situations and reducing power consumption and increasing battery efficiency even in the occurrence of ping-pong. Accordingly, the present disclosure may solve a problem in which frequent ping-pong situations occurring in an LP-WUS boundary region due to the mobility of IoT devices and ping-pong situations occurring due to unstable MR/LR reception states caused by degradation in the radio environment act as factors increasing battery consumption of the devices.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A wireless communication method performed by a user equipment (UE), comprising:
receiving, by the UE, information about one or more Low-Power Wake-Up Signal (LP-WUS) threshold zones and threshold information corresponding to each LP-WUS threshold zone from a base station;
determining, by the UE, whether the UE belongs to any one of the one or more LP-WUS threshold zones based on a location value indicating a location of the UE; and
determining, by the UE, whether to enter LP-WUS monitoring based on an LP-WUS entry threshold included in threshold information corresponding to the determined LP-WUS threshold zone and a radio measurement value measured by the UE.

2. The wireless communication method of claim 1, wherein the location value is received by the base station or estimated by the UE.

3. The wireless communication method of claim 1, wherein the location value includes at least one of absolute coordinate information, cell-based location information, zone-based location information, or information indicating a relative location, or a combination thereof.

4. The wireless communication method of claim 1, wherein the radio measurement value includes at least one of Reference Signal Received Power (RSRP), Reference Signal Received Quality (RSRQ), or timing information, or a combination thereof measured through a main receiver (MR) or a low-power receiver (LR) of the UE.

5. The wireless communication method of claim 1, wherein the information about the LP-WUS threshold zones includes zone identification information for identifying an LP-WUS threshold zone and information indicating a spatial range of each zone.

6. The wireless communication method of claim 1, wherein determining whether to enter the LP-WUS monitoring comprises comparing, by the UE, an LP-WUS entry threshold corresponding to the determined LP-WUS threshold zone with a radio measurement value measured through a main receiver of the UE and determining whether the radio measurement value satisfies the LP-WUS entry threshold.

7. The wireless communication method of claim 1, wherein the LP-WUS threshold zones are determined to have identical sizes or different sizes.

8. The wireless communication method of claim 1, wherein
the LP-WUS threshold zones include a plurality of LP-WUS threshold zones having different thresholds, and
the threshold information includes different thresholds depending on an LP-WUS threshold zone entered by the UE.

9. The wireless communication method of claim 1, further comprising:
after the UE enters the LP-WUS monitoring, determining whether to exit the LP-WUS monitoring based on a radio measurement value measured through a low-power receiver and an LP-WUS exit threshold included in the threshold information corresponding to the LP-WUS threshold zone.

10. The wireless communication method of claim 1, further comprising:
even though an exit condition is satisfied after entering the LP-WUS monitoring, maintaining an LP-WUS state for a predefined time period and then determining whether to exit the LP-WUS state.

11. The wireless communication method of claim 10, wherein the predefined time period, X, is determined to be T1 that satisfies (T1×W3)−(T1×W2)≥W1 based on W1, W2, and W3
where W1 denotes total power consumption from entry into LP-WUS monitoring to immediate exit, W2 denotes power consumption per unit time during the time period T1 after entry into the LP-WUS monitoring, and W3 denotes power consumption per unit time during the time period T1 after entry into LP-WUS eDRX or DRX.

12. The wireless communication method of claim 1, further comprising:
transmitting, by the UE, first location information including the location value and the radio measurement value to the base station; and
transmitting, by the UE, second location information including a second location value indicating a location of the UE after entry into the LP-WUS monitoring and a second radio measurement value corresponding to the second location value to the base station,
wherein:
the second radio measurement value includes an RSRP/RSRQ value of a main receiver (MR) corresponding to the second location value and a location value and an RSRP/RSRQ value of an LP-SS of a low-power receiver (LR) when an LP-WUS exit condition is satisfied, and
the LP-WUS threshold zones are generated or updated based on the first location information or the second location information.

13. A wireless communication method performed by a base station, comprising:
configuring, by the base station, one or more Low-Power Wake-Up Signal (LP-WUS) threshold zones and threshold information corresponding to each LP-WUS threshold zone based on location information reported from a user equipment (UE); and
transmitting, by the base station, information about the one or more LP-WUS threshold zones and the threshold information corresponding to each LP-WUS threshold zone to a UE entering a cell.

14. The wireless communication method of claim 13, wherein the location information includes a location value indicating a location of the UE and a radio measurement value.

15. The wireless communication method of claim 14, wherein the radio measurement value includes at least one of Reference Signal Received Power (RSRP), Reference Signal Received Quality (RSRQ), or timing information, or a combination thereof measured through a main receiver (MR) or a low-power receiver (LR) of the UE.

16. The wireless communication method of claim 13, wherein the LP-WUS threshold zones configured by the base station include uniform zones configured to have identical sizes or non-uniform zones configured to have different sizes.

17. The wireless communication method of claim 13, wherein
the information about the LP-WUS threshold zones includes zone identification information for identifying an LP-WUS threshold zone or information indicating a spatial range of the LP-WUS threshold zone, and
the threshold information includes an entry threshold for entry into LP-WUS monitoring and an exit threshold for exit from LP-WUS monitoring.

18. The wireless communication method of claim 13, wherein transmitting the information about the one or more LP-WUS threshold zones and the threshold information comprises transmitting the information about the LP-WUS threshold zones and the threshold information through system information when the UE moves from outside to inside a coverage area of the cell.

19. The wireless communication method of claim 13, further comprising:
receiving, by the base station, updated location information from the UE entering the cell; and
dynamically reconfiguring, by the base station, the LP-WUS threshold zones or the threshold information based on the updated location information.

20. A user equipment (UE) for wireless communication, comprising:
a communication unit configured to receive information about one or more Low-Power Wake-Up Signal (LP-WUS) threshold zones and threshold information corresponding to each LP-WUS threshold zone from a base station; and
a controller configured to determine whether the UE belongs to any one of the one or more LP-WUS threshold zones based on a location value indicating a current location and to determine whether to enter LP-WUS monitoring based on threshold information corresponding to the determined LP-WUS threshold zone and a radio measurement value measured at the current location.
